(19) United States
(12) Patent Application Publication
(10) Pub. No.: US 2022/0359941 A1
(43) Pub. Date: Nov. 10, 2022

(54) MODULE HOUSING FOR A BATTERY MODULE, A BATTERY MODULE, A SIDE PANEL UNIT, AND A METHOD FOR PROVIDING A BATTERY MODULE

(71) Applicant: AUDI AG, Ingolstadt (DE)

(72) Inventor: Walter SCHMIEDER, Hepberg (DE)

(73) Assignee: AUDI AG, Ingolstadt (DE)

(21) Appl. No.: 17/698,324

(22) Filed: Mar. 18, 2022

(30) Foreign Application Priority Data
May 4, 2021 (DE) 102021111441.1

(51) Int. Cl. H01M 50/209; H01M 10/653; H01M 10/658; H01M 10/625

(52) U.S. Cl. CPC H01M 50/209; H01M 10/653; H01M 10/658; H01M 10/625; H01M 2220/20

(57) ABSTRACT

A module housing for a battery module for receiving a cell stack with several battery cells arranged adjacently in a stacking direction. The module housing has a first end panel unit and a second end panel unit for delimiting the cell stack on either side in the stacking direction, and two side panel units, each having a side panel. The first and second end panel units and the two side panel units are arranged relative to one another, such that they enclose a receiving area for receiving the cell stack. The side panel thus includes a base frame, which is formed from an electrically insulating material, and which directly connects the receiving area, and a metal strip, which extends at least over a total length of the receiving area in a longitudinal direction, and which does not adjoins the receiving area.

### FIELD

The invention relates to a module housing for a battery module for receiving a cell stack comprising several battery cells of the battery module arranged adjacently in a stacking direction. In this case, the module housing has a first end panel unit and a second end panel unit for delimiting the cell stack on either side in the stacking direction, as well as two side panel units, each having a side panel, wherein the first end panel unit and the second end panel unit are connected to one another by means of the two opposing side panels, which extend in a predetermined longitudinal direction, wherein the first and second end panel units and the two side panel units are arranged with respect to one another, such that a receiving area for receiving the cell stack is enclosed by them. The invention further relates to a battery module having such a module housing, a side panel unit for such a module housing, and a method for providing a battery module.

### BACKGROUND

High-voltage batteries for electric or hybrid vehicles are usually constructed, such that an overall battery housing receives several battery modules, which in turn comprise several battery cells. The battery cells of a battery module are generally arranged adjacently in the form of a cell stack, and may also be separated from one another by panels arranged between the respective battery cells for electrical and thermal insulation. A module housing for such a battery module is often provided in the form of a frame around the cell stack. Such a frame can thus have two end panel units, which then delimit the cell stack in the stacking direction, as well as two side panels, via which the end panel units are connected to one another. At the same time, such a frame can also assume the function of bracing the cell stack. Battery modules with prismatic cells and/or pouch cells are generally prestressed during assembly, i.e., a prestressing force is applied to the cell stack via the end panel units and this prestressing force is then stabilized via the module housing or a mechanical bandage, or the like. This tensioning of the cell stack serves as a measure to prevent the cells from aging too quickly and thus enables a long service life. In particular, the tensioning force is intended to counteract the charge-related and age-related swelling of the battery cells. Accordingly, large forces act on the side panels, via which the end panel units are connected to one another. In other words, these side panels must meet high mechanical standards. That is why they are made from metal, especially sheet steel or stainless steel, in order to meet these high standards. In addition, since the battery cell housings are generally made from metal, the side panels, as well as the end panel units, must be electrically insulated from the battery cells. This is done, for example, by inserting an additional plastic insert between the end panel units and the cell stack, or by gluing an electrically insulating film to the end panel units in the direction of the receiving area. These side panels can be covered with a plastic film on the inside, i.e., facing the receiving area, in order to provide electrical insulation to the battery cells. If such insulation is damaged, e.g., in the event of a motor vehicle accident, there is a risk of a short circuit between battery cells and the module housing. In addition, conventional module housings have a high weight.

DE 10 2013 210 932 A1 describes a battery housing for receiving a battery cell, wherein a wall of the battery housing comprises a channel for receiving a temperature control agent, and the battery cell may be temperature controlled in the channel by means of the temperature control agent. The battery housing or the wall with the cooling channel can comprise a polymer material, e.g., a fiber-reinforced polymer material.

Furthermore, EP 3 053 206 B1 describes a battery module with a battery module housing, which encloses a battery module interior and which has receptacles on the battery module interior side for a predetermined number of battery cells. In this case, the battery module housing has a safety wall section in the area of at least one receptacle, the material properties and thickness thereof are such that the safety wall section will exhibits the fastest possible burn-through. This is intended to form an opening in the battery module housing in the event of a battery fire, such that the energy released by the flame can escape from the battery module through the resulting opening in the battery module housing. For this purpose, the safety wall section can be formed from a corresponding plastic.

### SUMMARY

The object of the present invention is to provide a module housing, a battery module, a side panel unit, and a method making it possible to provide a module housing, which can satisfy very high mechanical requirements and at the same time is designed to be as safe and efficient as possible.

This object is achieved by a module housing, a battery module, a side panel unit and a method.

A module housing according to the invention for a battery module for receiving a cell stack having several battery cells of the battery module arranged adjacently in a stacking direction comprising a first end panel unit and a second end panel unit for delimiting the cell stack on either side in the stacking direction, and two side panel units each having a side panel, wherein the first end panel unit and the second end panel unit are connected to each other by means of the two opposing side panels extending in a predetermined longitudinal direction, wherein the first and second end panel units and the two side panel units are arranged with respect to each other, such as to enclose an accommodation area for receiving the cell stack. In this case, the side panel of at least one of the side panel units has a base frame which is formed from an electrically insulating material and which is directly adjacent to the receiving area, and a metal strip which extends at least over a total length of the receiving area in the longitudinal direction, and which is not adjacent to the receiving area.

The invention is based on the realization that electrically insulating materials, such as plastics, are significantly lighter than metals and also permit a significantly more cost-effective design of components than do metals, and are also particularly advantageous for use in a module housing, due to their electrically insulating properties, however, they are subject to significantly less mechanical stress than components made from metallic material. By combining a base frame made from an electrically insulating material, in particular a plastic, with a metal strip to form a side panel, the great advantages of both plastic and metal can be combined, particularly in order to provide a module housing. The fact that the side panel is not made entirely of metal, in particular preferably not even mostly of metal in terms of its total volume, but rather of an electrically insulating material, in particular a plastic, results in enormous weight savings, and, at the same time, it is possible to provide electrical insulation of the metal strip with respect to the cell stack by means of the base frame provided in this way. A separate insulating film is therefore no longer necessary. Neverthelesss, the metal strip can advantageously provide the required mechanical stability of such a side panel. Thus, side panels provided in this way can easily withstand the tensioning forces to be applied to the cell stack. Furthermore, a particularly great advantage of this design of the side panel is that this metal strip also makes it possible to connect the side panel to the two end panel units in a particularly simple and stable manner. In particular, for example, the ends of this metal strip can be welded to the end panel units, which are preferably metallic or at least comprise metallic components, as will be explained in more detail later. Such stable connections cannot usually be provided, e.g., between plastics and metals, at least not in a simple way. Thus, the invention advantageously makes it possible to provide a stable and mechanically very durable module housing for a battery module, which has a significantly higher insulation safety due to the electrically insulating base frame and also allows for a particularly low weight and simple and inexpensive manufacture.

The battery module, for which the module housing is to be used, can be constructed as described at the outset. In addition to the module housing, the battery module can have a cell stack which is accommodated in the module housing. Such a cell stack may in turn have several battery cells, e.g., lithium-ion cells, arranged next to each other in the stacking direction, which are also preferably in the form of prismatic cells. As also described at the outset, separator panels or cell separators for electrical and thermal insulation can be arranged between the individual battery cells in the stacking direction. Accordingly, such a cell stack may have a substantially cuboid geometry after assembly. Thus, the receiving area may also have a cuboid geometry. Accordingly, a rectangular area may be enclosed by the end panel units and the respective side panels.

If such a cell stack is accommodated as intended in a module housing according to the invention or in one of its embodiments, then the stacking direction corresponds to the predetermined longitudinal direction. The end panel units may further comprise several individual components, such as an inner end panel arranged on the side of the corresponding end panel unit facing toward the receiving area, and an outer end panel arranged on the side of the inner end panel facing away from the receiving area on said inner end panel. A control unit, e.g., a cell management controller, may be accommodated in this outer end panel. Both the inner and outer end panels can be made from metal or include metallic components. Here, a metal should also understood to mean an alloy of different metals.

Furthermore, it is preferred that the module housing does not have a housing base. In contrast, the module housing can include a cover, which can be placed from above on the frame provided by the side panel units and end panel units. If a cell stack is arranged in the module housing as intended, then the cell poles face toward this cover. Since the module housing is open on the underside, i.e., does not have a module housing base, a battery module provided in this way can be inserted in an overall battery housing, e.g., together with other battery modules, whereby a cooling device can be provided by the housing base provided by this overall battery housing. This makes it possible to connect the battery cells of the battery module directly to such a cooling bottom of the overall battery housing.

Furthermore, both side panels of the two side panel units of the module housing can also be of the same design, which is also preferred due to the above-described advantages. Nevertheless, it is conceivable in principle to design the two side panel units differently.

The base frame of the side panel is further preferably designed, such that, in the case of a stack of cells accommodated in the module housing, it completely covers the sides of the battery cells facing toward the base frame. The base frame can thus be designed, e.g., as a continuous plastic panel, which has a substantially rectangular shape. Optionally, plastic moldings can be provided on one side, e.g., an upper side, e.g., for cable routing in the battery. These plastic molds can be provided, e.g., in the form of holders for cables, or even as a cable ducts. The formation of the base frame of the side plate from a plastic, such as, e.g., PE (polyethylene), consequently has the further major advantage that additional components, such as the described cable guide elements or retaining elements, can be integrated much more easily and cost-effectively. They can, for example, be manufactured in the same manufacture step used for providing the base frame, e.g., by an injection molding process. Previously, it was necessary to manufacture such components separately and mount them on the metal component in order to provide the conventional side panels in additional manufacturing steps.

In a further advantageous embodiment of the invention, the metal strip is arranged on the base frame on a side facing away from the receiving area, and in particular is fastened on the base frame. For example, the metal strip may be attached to the base frame by hot caulking or other suitable joining technique for joining metal parts to plastic parts. For example, the metal strip may also be glued to the base frame.

In principle, it is also conceivable that the metal strip is integrated, e.g., into the base frame, or at least largely cast into the base frame during manufacture. However, attaching the metal strip to the outside of the base frame has the advantage that this is much easier to manufacture and, in addition, the metal strip is thus at a greater distance from the battery cells, which are accommodated in the module housing, whereby greater safety can be provided, especially in the event of an accident.

Furthermore, it is preferred that the metal strip is made from steel or stainless steel, especially preferred, by galvanized steel. As a result, particularly high mechanical stability and a cost-effective design can be provided.

In addition, the side panel may have one such metal strip, which is preferred, however, several metal strips running parallel to each other may also be provided.

In a further, very advantageous embodiment of the invention, the metal strip is longer in the longitudinal direction than the base frame and projects beyond the base frame on either side in the longitudinal direction. These protruding ends can thus advantageously be used to join the side panel to the end panel units. Accordingly, it is thus further preferred that respective portions of the metal strip extending beyond the base frame in the longitudinal direction are secured to the first and second end panel assemblies. For example, these protruding parts may be welded to the end panel assembly, e.g., to the inner or outer end panel of the above-described end panel assembly. This can provide a particularly stable and durable connection between the end panel units and the side panels. In particular, it can withstand the tensioning and swelling forces that typically occur in the cell module or battery module.

Furthermore, it is preferred that the metal strip is shorter than the base frame in a direction perpendicular to the longitudinal direction, i.e., in particular in the direction of a height. The height may be defined in a direction from the open bottom of the module housing to the module housing cover. The side panels extend in the longitudinal direction, as described, while the end panels extend perpendicularly thereto in the direction of width, whereby the width is also perpendicular to the height. The fact that the metal strip has a lower height than the base frame ensures that the metal strip cannot come into contact with the battery cells, which are accommodated in the module housing. Furthermore, additional weight can thus be saved.

In a further advantageous embodiment of the invention, the metal strip has at least one stiffening contour, e.g., a stiffening rib, extending in the longitudinal direction. Such three-dimensional contours, which can be provided simply as, e.g., embossing, can increase the overall stiffness and robustness of such a metal strip. In particular, this may increase the tensioning force in the longitudinal direction. This also allows a reduced height and/or thickness of the metal strip perpendicular to the height and longitudinal direction. For example, the height of the metal strip may be approximately half the height of the base frame, which may be, e.g., 115 mm tall. The thickness of the metal strip is preferably in the single-digit millimeter range or less, e.g., about 1-1.5 mm.

In another very advantageous embodiment of the invention, the side panel unit has an insulating panel made from an electrically insulating material, which connects one end of the base frame in a material-bonded fashion thereto and encloses an angle therewith, in particular of about 90°, wherein the insulating panel is arranged between the first or second end panel unit and the accommodating area, in particular, such that a cell stack accommodated in the accommodating area does not contact the first or second end panel unit. This insulating panel advantageously eliminates the need for the plastic insert or insulating film mentioned at the outset between the relevant end panel unit and the cell stack. The main advantage of this design is primarily that such a plastic insert no longer needs to be manufactured and inserted separately, but can be provided as part of the side panel unit. In particular, for example, the base frame and this insulating panel may be manufactured as a common flat plastic part or as a plastic panel, in which case, rectilinear material weakening can be introduced into this plastic panel in order to delimit the base frame from the insulating panel. This material weakening along this straight line provides a corresponding bending edge in the plastic, and can be provided, e.g., by an inserted groove or embossing line. This plastic panel can thus be bent by 90° along this bending edge, which then ultimately provides the insulating sheet that is adjacent to the base frame and materially bonded thereto. In other words, the insulating sheet can be provided by bending a portion of an originally provided plastic panel. The remaining, non-buckled part ultimately provides the base frame, upon which the metal strip is arranged as described. Thus, both the side panel and the insulating panel between the cell stack and the end panel unit can be provided by one component. This has the further major advantage that gaps between the base frame and the insulating panel, which are made from the same component and remain materially bonded to one another even after bending, can be avoided. This is particularly advantageous in terms of insulation safety, since a risk of short circuits can also result over time from changing gap widths between insulating parts.

In this regard, the two side panel units are preferably designed, such that one side panel unit provides an insulating panel between the first end panel unit and the receiving area, and the other side panel unit provides a corresponding insulating panel between the receiving area and the second end panel unit. In this way, the two side panel units can provide insulation that completely encloses the receiving area. This allows significantly more efficient manufacture and a reduction in the total number of individual components required.

For example, in order to avoid a possible gap formation between the insulating panel of a first side panel unit and the base frame of the other side panel unit adjacent in the direction of rotation, the insulating panel of one of the side panel units may be connected, e.g., by a further insulating section bent by 90°, which overlaps the base frame of the other of the side panels. Alternatively, such an insulating section bent by 90° may also connect to the base frame on the side opposite the insulating panel, such that this insulating section overlaps, at least partially, the insulating panel of the other side panel unit in the direction of rotation. Similarly, such overlaps may increase insulation safety, especially at the corners of the receiving area by avoiding gaps and furthermore, ensure this over time, especially when the module expands during its service life.

As already mentioned, it is advantageous if the boundary between the base frame and the insulating panel is formed with a material weakening, in particular an indentation. In this way, a bending edge can advantageously be provided during manufacture, such that the insulating panel can be easily bent or folded relative to the base frame, whereby it can be inserted at a predetermined angle, such as 90°. The same applies to the additional insulating section.

Furthermore, the invention also relates to a battery module with a module housing according to the invention or one of its embodiments. The advantages described for the module housing according to the invention and its embodiments likewise apply to the battery module according to the invention. In addition, the battery module according to the invention preferably comprises a cell stack accommodated in the receiving space, which may be designed as described above. The stacking direction corresponds to the longitudinal direction of the module housing or the side panels.

Furthermore, the invention also relates to a side panel unit for a module housing, in particular for a module housing according to the invention or one of its embodiments. In particular, this side panel unit may be designed as described above with respect to the module housing according to the invention or its embodiments. Accordingly, a side panel unit for a module housing for a battery module receiving a cell stack comprising several battery cells of the battery module arranged adjacently in a stacking direction into a receiving area of the module housing is provided, wherein the side panel unit comprises a side panel adapted to connect two end panel units of the module housing. Furthermore, the side panel has a base frame made from an electrically insulating material for direct placement on the receiving area, and a metal strip extending at least over an entire length of the base frame in the longitudinal direction, and which does not adjoin the receiving area.

Furthermore, the invention also relates to a method for providing a battery module, wherein a cell stack comprising several battery cells arranged adjacently in a stacking direction is provided, two end panel units for delimiting the cell stack on either side in the stacking direction are provided, and two stack panel units each comprising a side panel are provided. Furthermore, the two end panel units are connected by means of the two side opposing panels extending in a predetermined longitudinal direction, such that the first and second end panel units and the two side panel units are arranged relative to one another, whereby they enclose a receiving area, in which the cell stack is accommodated. Further, the side panel of at least one of the side panel units comprises a base frame made from an electrically insulating material and a metal strip extending over at least an entire length of the receiving area in the longitudinal direction, wherein the side panel is arranged on the two end panel units, such that the base frame directly adjoins the cell stack accommodated in the receiving area, and the metal strip does not adjoin the cell stack.

Again, the advantages described for the module housing according to the invention and its embodiments apply equally to the method according to the invention.

An advantageous further embodiment of the method according to the invention, provides that, when providing the two side panel units, at least one of the side panel units is provided with an insulating panel made from an electrically insulating material, which connects one end of the base frame in the longitudinal direction and is situated in a plane with the base frame, wherein the insulating panel is bent by an angle relative to the base frame, in particular by 90°, before fastening the side panel to the end panel units, and the side panel unit is arranged on the cell stack, such that the insulating panel is arranged between one of the end panel units and the cell stack, in particular, such that a cell stack accommodated in the receiving area does not contact the first or second end panel unit, respectively.

Prior to attaching the side panels to the end panel units by fastening the protruding ends of the above-described metal strip, the cell stack may be compressed by applying force in the stacking direction, in particular a force of 8 kN, after which the metal strip may be welded to the end panel units. The application of force can then be ended. This allows the cell stack to be clamped into the frame provided by the module housing.

The invention also includes further embodiments of the motor vehicle according to the invention, which have the features described above in connection with the further embodiments of the method according to the invention. For this reason, the corresponding further embodiments of the method according to the invention are not described again here.

A battery with a battery module according to the invention, as well as a motor vehicle with such a battery, which is preferably designed as a high-voltage battery, is also to be regarded as belonging to the invention. The motor vehicle according to the invention is preferably designed as a motor vehicle, in particular as a passenger car, a truck, a minibus, or a motorcycle.

The invention also includes combinations of the features of the above-described embodiments. Thus, the invention also includes implementations, each comprising a combination of the features of several of the described embodiments, on condition that the embodiments have not been described as mutually exclusive.

### BRIEF DESCRIPTION OF THE FIGURES

Examples of embodiments of the invention are described below. In the drawings:

FIG. 1 a schematic exploded view of a battery module with a module housing according to an exemplary embodiment of the invention; and

FIG. 2 a schematic diagram of a side panel assembly for a module housing prior to assembly according to an exemplary embodiment of the invention.

### DETAILED DESCRIPTION

The exemplary embodiments explained below are preferred embodiments of the invention. In the exemplary embodiment, the described components of the embodiments each represent individual features of the invention, which are to be considered independently of one another, and which further develop the invention independently of one another. Therefore, the disclosure is intended to include combinations of the features of the embodiments other than those shown. Furthermore, the described embodiments can also be supplemented by further features of the invention, which have already been described.

In the figures, identical reference numerals refer to functionally identical elements.

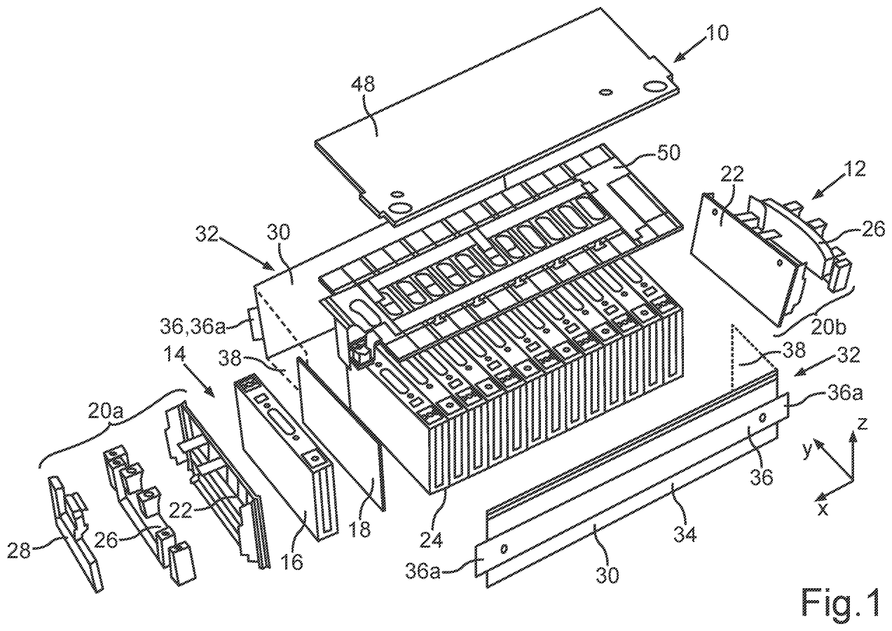

FIG. 1 shows a schematic exploded view of a battery module 10 with a module housing 12 according to an exemplary embodiment of the invention. In addition to the module housing 12, the battery module 10 includes a cell stack 14 having several battery cells 16 arranged adjacently in a stacking direction x. A cell separator element 18 may also be placed between two battery cells 16 arranged adjacently in order to electrically and thermally insulate the battery cells 16 from one another. For example, such a battery module 10 or cell stack 14 may include sixteen battery cells 16 and by analogy, fifteen cell separators 18. The stacking direction x corresponds to a longitudinal direction x of the module housing 12. The latter comprises two end panel units 20a, 20b delimiting the cell stack 14 in stacking direction x. Each of these may include an inner end panel 22, each facing the receiving area 24 in which the cell stack 14 is accommodated, and an outer end panel 26, each facing away from the receiving area 24. Furthermore, a control unit 28, e.g., a cell management controller, may also be arranged, e.g., on the outer end panel 26 of the first of the end panel units 20a. These two end panel units 20a are further interconnected on either side by two side panels 30 extending in the longitudinal direction x. The side panels 20 are arranged opposingly. The side panels 30, along with the end panel units 20a, 20b, enclose a cuboid receiving area 24, in which the cell stack 14 is arranged. These respective side panels 30 are part of a side panel unit 32. Such a side panel 30 has a base frame 34 made from an electrically insulating material. This base frame 34 is preferably made at least mostly of plastic, or alternatively entirely of plastic. Furthermore, each side panel 30 has a metal strip 36. This metal strip 36 is arranged on the outside of the plastic body 34, i.e., on a side of the base frame 34 facing away from the receiving area 24. Furthermore, this metal strip 36 is smaller in the z-direction than the base frame 34. In contrast, the metal strip 36 is longer in the x-direction, i.e., in the longitudinal direction x, than the base frame 34. As a result, projecting ends 36a of the metal strip are provided on either side of the base frame 34, whereby the side plates can each advantageously be attached to the end plate units 20a, 20b, e.g., by welding. Such a metal strip 36 may be made, e.g., of galvanized or stainless steel. The plastic part provided by the base frame 34 covers the entire side of the module, i.e., the base frame 34 extends over the entire side surface of the cell stack 14 facing it.

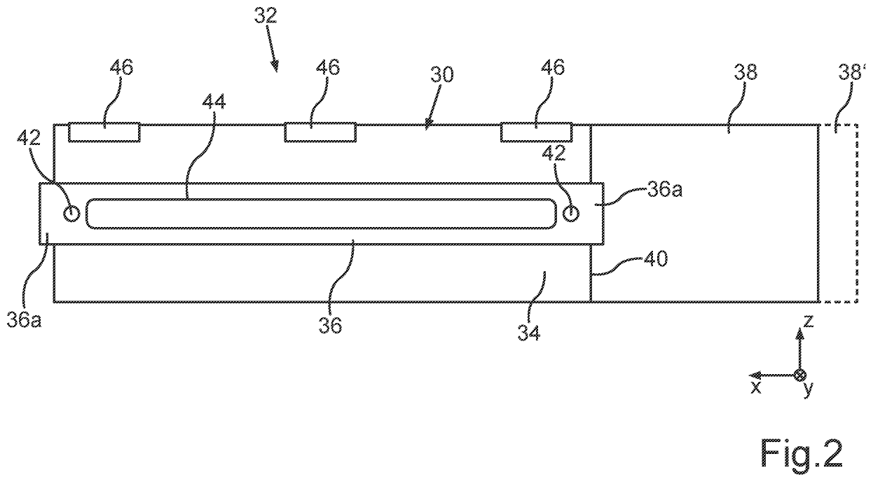

Furthermore, an insulating panel 38, which is indicated schematically only by a dashed line in FIG. 1, is connected to the base frame 34 by a material bond. FIG. 2 again shows a detailed view of a side panel unit 32 in an initial state prior to assembly. Thus, the base frame 34 and the insulating panel 38 may be provided from a common plastic part. Then, the insulating part 38 can be bent by bending about a provided bending edge 40 by, e.g., about 90° relative to the base frame 34, in order to assume the shape shown in FIG. 1. Such a bending edge 40 may be provided, e.g., by a corresponding material weakening of the plastic panel 34, 38. Preferably, both side panel assemblies 32 of the module housing 12 are provided in this manner. As a result, the cell stack 14 is circumferentially enclosed by insulation provided by the described plastic parts of the two side panel units 32. These plastic parts, i.e., their respective base frames 34, including the corresponding insulating panels 38 connected thereto, protect the battery module or the cell stack 14 from foreign bodies or short circuits. Since one side of the plastic part of the side panel unit 32 is correspondingly elongated and designed to be bent through 90°, this thus-provided insulating panel 38 may advantageously serve to insulate the end panel or end panel unit 20a, 20b. Accordingly, the battery module 10 is assembled, such that ultimately these respective insulating panels 38 of the respective side panel units 32 are located between the cell stack 14 and the inner end panel 22 of the respective end panel units 20a, 20b. Thus, two parts for the battery module 10 will be saved. In order to further increase insulating safety, a further insulating section 38′ may be provided on the side of the insulating panel 38 opposite the base frame 34, which can be bent through 90° relative to the insulating panel, such that it also stays connected to the insulating panel 38 in a material-bonded fashion, but is aligned parallel to the base frame 34. As a result, this insulating section 38 overlaps the base frame 34 of the other side panel assembly 32 in the assembled module 10. Thus, gaps in corner areas can be completely avoided. Alternatively, this insulating section 38′ indicated by dashed lines in FIG. 2 may also be arranged on the base frame 34 on the side opposite the insulating panel 38.

The metal strip 36 may be joined to the base frame 34 by one or more joints 42, e.g., by hot caulking. Furthermore, the metal strip 36 preferably includes a stiffening contour 44, which may increase the strength of the metal strip 36. Moreover, formations 46 may still be provided on the upper side of the base frame 36, e.g., in the form of holders, which may be used to guide the cables in the battery. Furthermore, as shown in FIG. 1, module 10 may still include a cell interconnection device 50 above the cells 16, including a lid 48, which closes the top of module 10.

On the whole, the examples show how the invention can provide an optimized side panel for prismatic cell modules, which makes it possible to increase the protection of sensitive cells against short circuits and save on several parts of a battery module. What's more, a substantially lower weight of the side panels can be achieved. Such side panels or side panel units are installed in the battery twenty-four fold. This will allow for saving an enormous amount of weight. Costs may also be reduced thereby.

1. A module housing for a battery module, for receiving a cell stack comprising several battery cells of the battery module arranged adjacently in a stacking direction, wherein the module housing comprises:
a first end panel unit and a second end panel unit for delimiting the cell stack on either side in the stacking direction; and
two side panel units each having a side panel, wherein the first end panel unit and the second end panel unit are connected to one another by means of the two opposing side panels extending in a predetermined longitudinal direction,
wherein the first and second end panel units and the two side panel units are arranged relative to one another, such that they enclose a receiving area for receiving the cell stack,
wherein
the side panel of at least one of the side panel units comprises a base frame, which is made from an electrically insulating material and which directly connects the receiving area, and a metal strip, which extends at least over a total length of the receiving area in the longitudinal direction, and which does not adjoin the receiving area.

2. The module housing according to claim 1, wherein the metal strip is arranged on the base frame on a side facing away from the receiving area, and in particular is fastened to the base frame.

3. The module housing according to claim 1, wherein the metal strip is longer in the longitudinal direction than the base frame and projects beyond the base frame on either side in the longitudinal direction, wherein respective parts of the metal strip projecting beyond the base frame in the longitudinal direction are attached to the first and second end panel units.

4. The module housing according to claim 1, wherein the metal strip has at least one stiffening contour extending in the longitudinal direction.

5. The module housing according to claim 1, wherein the side panel unit has an insulating panel made from an electrically insulating material, which connects one end of the base frame in a material-bonded fashion and encloses an angle therewith, in particular about 90°, wherein the insulating panel is arranged between the first or second end panel unit and the receiving area, in particular such that a cell stack accommodated in the receiving area does not contact the first or second end panel unit.

6. The module housing according to claim 1, wherein the boundary between the base frame and the insulating panel is formed with a material weakening, in particular an indentation.

7. A battery module comprising a module housing according to claim 1, and a cell stack accommodated in the receiving area.

8. A side panel unit for a module housing for a battery module for receiving a cell stack comprising several battery cells of the battery module arranged adjacently in a stacking direction into a receiving area of the module housing, wherein the side panel unit comprises a side panel adapted to connect two end panel units of the module housing, wherein the side panel comprises a base frame formed from an electrically insulating material for direct placement on the receiving area, and a metal strip extending at least over a total length of the base frame in the longitudinal direction, which metal strip is not adjacent to the receiving area.

9. A method for providing a battery module, comprising the steps of:
providing a cell stack having several battery cells arranged adjacent to one another in a stacking direction;
providing two end panel units for delimiting the cell stack on either side in the stacking direction;
providing two side panel units, each having a side panel (30); and
connecting the two end panel units by means of the two opposing side panels extending in a predetermined longitudinal direction, such that the two end panel units and the two side panel units are arranged relative to one another, such that they enclose a receiving area in which the cell stack is accommodated;
wherein
the side panel of at least one of the side panel units comprises a base frame formed from an electrically insulating material and a metal strip extending at least over a total length of the receiving area in the longitudinal direction, wherein the side panel is arranged on the two end panel units, such that the base frame directly adjoins the cell stack accommodated in the receiving area, and the metal strip does not adjoin the cell stack.

10. The method of claim 9, wherein when the two side panel units are provided, at least one of the side panel units is provided with an insulating panel made from an electrically insulating material, which connects one end of the base frame in the longitudinal direction in a material-bonded fashion and is situated in a plane with the base frame, wherein the insulating panel is bent through an angle relative to the base frame prior to fastening the side panel to the end panel units, and the side panel unit is arranged on the cell stack, such that the insulating panel is arranged between one of the end panel units and the cell stack, in particular such that a cell stack accommodated in the receiving area does not contact any of the end panel units.

11. The module housing according to claim 2, wherein the metal strip is longer in the longitudinal direction than the base frame and projects beyond the base frame on either side in the longitudinal direction, wherein respective parts of the metal strip projecting beyond the base frame in the longitudinal direction are attached to the first and second end panel units.

12. The module housing according to claim 2, wherein the metal strip has at least one stiffening contour extending in the longitudinal direction.

13. The module housing according to claim 3, wherein the metal strip has at least one stiffening contour extending in the longitudinal direction.

14. The module housing according to claim 2, wherein the side panel unit has an insulating panel made from an electrically insulating material, which connects one end of the base frame in a material-bonded fashion and encloses an angle therewith, in particular about 90°, wherein the insulating panel is arranged between the first or second end panel unit and the receiving area, in particular such that a cell stack accommodated in the receiving area does not contact the first or second end panel unit.

15. The module housing according to claim 3, wherein the side panel unit has an insulating panel made from an electrically insulating material, which connects one end of the base frame in a material-bonded fashion and encloses an angle therewith, in particular about 90°, wherein the insulating panel is arranged between the first or second end panel unit and the receiving area, in particular such that a cell stack accommodated in the receiving area does not contact the first or second end panel unit.

16. The module housing according to claim 4, wherein the side panel unit has an insulating panel made from an electrically insulating material, which connects one end of the base frame in a material-bonded fashion and encloses an angle therewith, in particular about 90°, wherein the insulating panel is arranged between the first or second end panel unit and the receiving area, in particular such that a cell stack accommodated in the receiving area does not contact the first or second end panel unit.

17. The module housing according to claim 2, wherein the boundary between the base frame and the insulating panel is formed with a material weakening, in particular an indentation.

18. The module housing according to claim 3, wherein the boundary between the base frame and the insulating panel is formed with a material weakening, in particular an indentation.

19. The module housing according to claim 4, wherein the boundary between the base frame and the insulating panel is formed with a material weakening, in particular an indentation.

20. The module housing according to claim 5, wherein the boundary between the base frame and the insulating panel is formed with a material weakening, in particular an indentation.
